(19) United States
(12) Patent Application Publication
(10) Pub. No.: US 2023/0336062 A1
(43) Pub. Date: Oct. 19, 2023

(54) DC three-phase electric motor with disk-shaped coil technique for use in electric vehicles

(71) Applicant: Mahdi Fahimi, Tehran (IR)

(72) Inventor: Mahdi Fahimi, Tehran (IR)

(21) Appl. No.: 18/215,166

(22) Filed: Jun. 27, 2023

(51) Int. Cl. H02K 23/54

(52) U.S. Cl. CPC H02K 23/54

(57) ABSTRACT

A DC three-phase DC motor comprising disc coils having 12 independent windings, a rotor, disc-shaped stators, and an electronic control system. Independent windings form three separate phases, connected by switch circuits in three quadruple rows. Rotor having a circular array of electromagnetic coils; wherein the axis is parallel to the shaft. The electronic control system replaces the brush (charcoal) and the commutator to supply energy to the magnetic coils for pushing or pulling the electromagnetic magnets. By using three separate rows of four quadrants and removing the brush system (charcoal) and commutator, the simultaneous power distribution in the three-phase motor is provided by the electronic control circuit, and also effective torque is produced.

### TECHNICAL FIELD

DC commutator motors or generators having mechanical commutator; Universal AC/DC commutator motors (H02K 23/00)

### BACKGROUND ART

It has been a long time since the discovery of the law of induction by the English physicist Michael Faraday in 1831 and the American inventor Thomas Davenport who obtained the first patent for the DC electric motor in the United States (1837—132USA). Nikola Tesla of Serbia (1886—US 0382280) Frank Spree of the United States (1886— the USA) and Mikhail Dolio Dobrowolski of the Polish engineer who built the first cage-rotor motor in three-phase induction motors in 1889.

Significant progress was made in this area until the English inventor Cedric Lynch succeeded in building a unique motor with a permanent magnet shaft and commutator and a graphite charcoal brush system in 1979, which is the patent of Dec. 18, 1986. The Lynch electromotor could reach 70% efficiency. The motor was made of F-shaped blocks that were placed between metal strips instead of the usual copper coil windings and were held together perfectly by magnets. In 1989, Lynch, with the help of Richard Fletcher and his project team, William Ride of London's innovation network LIN, built a DC electric motor that produced 15 horsepower (11 kW). In the design of Lynch engine armature, iron laminates are made of narrow rectangular pieces arranged in parallel to form a complete circular ring. Since the magnetic flux passes only through the laminates along an axis, insulating materials (Charlock) can be used, which are commonly used in large transformers. The Lynch motor has a rotating armature located between two banks of eight fixed magnets on a spindle. There are also eight brushes (four negative, four positive) on the front that allow electricity to flow from the power source to the armature. The design of motor lynch reinforcement is significantly different from other types of motors. Reinforcement coils consist of U-shaped insulated copper strips like an adjusting fork. One leg is then bent 45 degrees clockwise, while the other leg is bent 45 degrees counterclockwise.

Before reaching the end of the armature, each coil base has several bends so that it can pass through the ferrite ring radially before the end of the 90-degree end. The outer edge of each copper strip has a hook that rotates 90 degrees with a 90-degree connection. The inner edge of the copper strips is just the insulation on the front that forms the traffic surface and the brushes are placed in it. Between each copper, coil bases are pieces of iron ferrite cores and the insulation formed by the ferrite ring. The ferrite ring carries the magnetic flux between the fixed magnets without the need to use copper strips to conduct electricity. As the armature rotates, current flows from a brush into the cylinder outward along one end of a copper coil. The electric current then reaches the center 90 degrees later and before reaching the corresponding brush from the opposite electric polarity of 135 degrees from the initial brush to the front. In traditional radial electric motors, it cannot be easily aligned with the direction of the magnetic field, but in Lynch axial motors, it leads to higher efficiency.

In 1992, Lynch, in collaboration with Lemco, was able to build a DC electromotor without commutators and charcoal, but the biggest drawback of the Lynch electromotor was its high volume and weight, and of course, its high electrical energy consumption.

In 1994, Hanselman completed the design of a brushless permanent magnet motor in McGraw Hill, New York, and the world's first electric helicopter, powered by a BLDC electric motor, was designed and flown by Pascal Curtin. The helicopter broke the Guinness Book of World Records on Aug. 12, 2011, and received the IDTechEx Land Sea & Air Electric Vehicle Award in 2012.

A coreless three-phase DC motor comprising a coil-type armature formed with insulated windings. The armature is of a disc- or cylindrical-shape and is set rotatably against a field magnet provided with 2n magnetic poles N and S magnetized in equal angular widths. On the surface of the armature, there are 3n/2 three-phase armature coils, wherein the angular width of each of the coils is equal to the width of the field magnet pole, the coils of each phase are shifted by 1800 of electrical angle from each other, and all the armature coils are arranged at equal angular intervals and not superimposed for one another.

According to the invention, the three-phase DC motor has a coil-type armature consisting of insulated windings, and a commutator and a disc-shaped armature are secured to the rotating shaft. The angular width of the armature coils is equal to the width of the magnetic field pole, and the coil or (coils) of one phase with an electric angle of 180 degrees is moved to the next phase and all armature coils at equal angular intervals on the armature they are placed and do not mount on top of each other, and by changing the way the armature coils are connected, the armature thickness can be reduced several times compared to the previous armature without any processing at the ends of the coil.

Electric D.C. motors with a plurality of units, each including a permanent magnet field device and a wound armature for producing poles—U.S. Pat. No. 4,535,263

An electric motor, such as a limited-rotation-angle type, has two or more motor units, including spaced stators enclosing respective rotors on a common shaft. Circumferential, spaced permanent magnets are mounted on the rotors. Stator windings are recessed in slots that are angularly offset to adjacent stator slots. This offset angle between spaced stators is equal to the slot pitch divided by the number of motor units. As a result, the cogging, or super-imposed varying torques of each motor section that occur as the magnets pass a stator slot, are out of phase, and thus substantially cancel out.

The above invention is for multi-unit DC electric motors, each consisting of a permanent magnetic field device and a twisted armature to create poles.

Electric motor—U.S. patent Ser. No. 10/075,031

An electric motor includes a yoke having six magnetic poles; a rotary shaft which is provided inside the yoke in a freely rotatable manner; an armature core which has teeth attached to the rotary shaft, radially extending in a radial direction and set in an arrangement of an even number, and an even number of slots formed between the teeth; an armature coil which is wound around the teeth in a single wave winding; and a commutator which is provided in the rotary shaft to be adjacent to the armature core and has a plurality of circumferentially disposed segments to which the armature coil is connected.

Inverter circuit comprising a circuit arrangement for regenerative damping of electrical oscillations, and method for regenerative damping of electrical oscillations—the United States Patent 20190006958

The invention relates to an inverter circuit for the alternating connection of the phases of single-phase or multi-phase, in particular three-phase load (M) to the positive and to the negative terminal of a DC source (U_{B}), having pairs of electronic switches (T₁, T₂, T₃, T₄, T₅, T₆) connected in parallel with one another and integrated into a power module (1), wherein the two switches belonging to the respective pair are connected in series, and wherein the connection for the respective phase (M₁, M₂, M₃) of the load (M) is provided at the connection of the two electronic switches belonging to the pair, having an intermediate circuit capacitor (C_{ZK}), which is connected in parallel to the DC source (U_{B}), and electric connections (2, 3) between the intermediate circuit N capacitor (C_{ZK}) and the power module (1) for the connection of the switch pairs (T₁, T₂, T₃, T₄, T₅, T₆), wherein the electric connections (2, 3) have distributed parasitic inductances (L_{PAR}) and, as a result, cause electrical oscillations when switched, comprising a circuit arrangement for regenerative damping of the electrical oscillations, having a buffer capacitor (C_{buff}, which is connected by the first connection thereof to a connection of the switch pairs (T₁, T₂; T₃, T₄; T₅, T₆), a first diode (D_{high}), via which the buffer capacitor (C_{buff}) is connected to the other connection of the switch pairs (T₁, T₂; T₃, T₄; T₅, T₆), further diodes (D_{low1}, D_{low2}, D_{low3}), via which the buffer capacitor (C_{buff}) is connected to the connections for the respective phase (M₁, M₂, M₃) of the load (M), and a step-down controller (T_{S}), via which the buffer capacitor (C_{buff}) is connected to the intermediate circuit capacitor (C_{ZK}).

### SUMMARY OF INVENTION

This invention is related to the field of DC electric motors and can be used with high power and low energy consumption with point-to-point control capability in the construction of high-power generators, electric motorcycles, and all-electric vehicles. Power transmission in this type of motorcycle is done by timing belts. In this type of power transmission, according to the simple law of wheels and axles, it is possible to design more than five types of electric motorcycles with different powers at different speeds with a three-phase electric motor with constant power. Also, the use of this type of electric motor in the construction of electric motorcycles produces high power, the appropriate speed, and minimum energy consumption for the user, which promotes a culture of using clean energy. The designed switching system can be activated using control signals from a control system for power supply and provide three sensors for three rows of coils (three phases) to generate signals related to the absolute and instantaneous positions of the rotors. On the other hand, electromagnetic coils also produce high amounts of magnetic flux, which causes less magnetic resistance to change rapidly or inversely in polarity (N and S).

Electric motors usually consist of a stator and a rotor that can be housed in a chamber. The rotor creates a magnetic field near the stator and consists of a series of permanent magnets attached to the shaft. The stator also creates magnetic field disturbances by moving the rotor to a position that minimizes magnetic field disturbances. The stator may also include a series of coils connected to the restraint. The restraint can accommodate a bearing to ensure rotation of the rotor to minimize magnetic field disturbances. These types of electric motors provide maximum torque at idle, which decreases linearly with increasing speed. The heat energy from the rotation of the rotor weakens the magnetic strength of the permanent magnets, which reduces the power of the DC motor. The inability to limit or control the speed of the motor is also a problem of these electric motors.

Electric motors control their peak efficiency by changing the switching time between the magnet phases (changing the S and N poles). This timing is traditionally set at the time of switching by changing the frequency of the controller drive circuit. Therefore, changes in the speed and power of the electromotor reduce the peak efficiency of the device. The purpose of the present invention is to stabilize the power and power of the motor even at low speeds to increase efficiency, which has been achieved by designing disk-shaped magnetic coils and independent windings with a three-phase DC design. Such problems have been eliminated due to the direct connection of the current to the rotating armature.

Today's electric motorcycles usually use a type of electric motor called a HUB MOTOR. These motors are installed in the center of the rear wheel of the motorcycle and fact the motor shell is the same wheel and therefore the motor power is limited to the central diameter of the wheel. This restriction has caused most electric motorcycle manufacturers to consider the maximum power of motor hubs from 2000 watts to 2500 watts. These types of engines must have a special design to build each model of motorcycle, which creates high costs in the cost price. Also, the low power of motor hubs has caused people to look at these types of motorcycles with toy eyes and distort the culture of using clean energy. Also, high energy consumption in these motors causes loss of battery charge in a very short time and increases the long charging time and high battery consumption.

All these above problems have been eliminated in the motorcycle model, which is made with a three-phase DC electric motor and has practically eliminated the unevenness of producing electric motorcycles with very high force-torque and low energy consumption. Power transmission in this type of motorcycle is done by timing belts. In this type of power transmission, according to the simple law of wheels and axles, a three-phase electric motor with a constant power of more than five types of electric motorcycles in different powers with different speeds can be designed. Also, the use of this type of electric motor in the construction of electric motorcycles provides high power, appropriate speed, and minimum energy consumption for the user, which promotes a culture of using clean energy. It is noteworthy that the three-phase electric motor made for electric motorcycles has a power of 4200 watts, which can be increased.

### Solution of problem

A big number of low volume, disk-shaped magnetic coils (152) packed in an aluminum housing are used in this electric motor. The aluminum coating acts as a heatsink in which heat loss is very little. This configuration provides weight and size reduction as well as output power increase, high efficiency, and the ability to maintain or combine with electrical devices. In this design, it is possible to control one or more coils independently. If less torque is required, parts can be turned off using the control circuit. These circuits are capable of controlling at least 70% of one or more magnetic windings and coils. Some are set up to let the electrical device control at least 60% of the coil independently.

In this disclosure, a three-phase DC motor with direct current is presented; the motor consists of 12 independent windings in three four-row rows, and the windings are connected together through a switch circuit (switching transistors). The three rows of coils make up three separate phases. The electromotor has a rotor with circular arrays of high-energy, alternating polarity electromagnetic coils. The axis of this type of electromagnetic magnet is parallel to the shaft. The stators are fixed in a disk parallel to the rotor and separated by small, even air gaps. Each stator is a circle of electromagnetic coils that are embedded around it on the central diameter of the rotor. Each disk-shaped stator consists of circular arrays of electromagnetic coils mounted at equal intervals around the rotor and on the central diameter of the rotor. The rotors are supported in rotation in parallel with the stators where the air gap is located. The central parts of the stators are cut to pass through the rotor carrier shaft, and the circuit of the electromagnetic coils to rotate the rotor can be integrated with an axis.

An electronic control system that replaces the brush (charcoal) and commutator can provide the energy needed for magnetic coils to push or pull electromagnetic magnets to generate kinetic energy in response to the inputs obtained from the measurement method and instructions for rotation (left or right).

The designed switching system can be activated using control signals from a control system for power supply and provide three sensors for three rows of coils (three phases) to generate signals related to the absolute and instantaneous positions of the rotors. While permanent magnets may be strong enough and rare earth type, electromagnetic coils produce high amounts of magnetic flux, and less magnetic resistance causes rapid or inverse changes in polarity (N and S). This disclosure only applies to the claimed three-phase direct current (DC) electric motor.

Control circuit: It is a switching oscillator (high-frequency oscillator circuit) and is formed using MOSFET (111) and inductor (88) transistors which have inductive properties. Mosfet transistor Tr 1 Tr 2 (IRF540N)—60 microfiber inductor, abrupt diode, and LM566CN IC, electrochemical capacitors, and rectifier diode bridge, resistor, and Zener diode are other elements used in the oscillator circuit are voltage controlled.

One of the most important requirements of any voltage-controlled oscillator in the phase lock loop is that the voltage-frequency curve is monotonic. In other words, this curve must change in such a way that the frequency usually increases with increasing voltage. Sometimes in some specimens and as a result of Spurious Resonances, this uniformity may not be present, which makes the ring unstable. For this reason, this condition must be prevented for the proper operation of the phase lock ring. To adjust the oscillator, changing the resonance point in the circuit is very necessary, which is the best way to achieve this goal by adding a capacitor at both ends of the inductor. In this circuit, inductive reactance is located between the base and the ground, so compared to other configurations, oscillating circuits are not at risk of problems such as false oscillations and other anomalies. To create a phase lock loop, the input signal is detected by the phase detector and after comparing it with the output signal and passing through the loop filter, the final output signal is obtained ([FIG. 13]). The current description uses 18 oscillator circuits controlled by two Micro Computer Units (113). MCUs are routed in a standard master-slave configuration in which one motor control unit is connected to only one common communication bus or several winding control units. MCU uses an ATMEGA 64 programmer IC and in its programming, the calculated sequences include:
1. Sequence-based activation (coils are guaranteed in rotational mode with alternating polarity, respectively)
2. Optimal force activation (coils are activated when their single feedback data indicates the application of the desired force to the rotor)
3. Optimal activation of efficiency (coils are activated in such a way as to minimize the dynamics of the motor power consumption)
4. Dynamic reduction of the number of active windings (less power per torque)
5. Dynamic reduction of active coil power percentage (smoother torque)
6. Modulation of a pulse width of the coil signal for the possibility of precise control of the power applied to the coils.

By creating a frequency by the oscillator and generating a magnetic charge that is placed through the inductor (88) at a certain distance from the disk-shaped magnetic coils, the electric motor starts to move. A DC to DC inverter circuit is used to power the electric motor. The diameter and length of the lacquered copper wire used in the above coils are designed, calculated, and fabricated for 4200 watts and 60 volts DC direct current electric motors. These values are 100% possible for the design and construction of electromotors with a higher power.

The armature shaft (10) is completely fixed to the aluminum shell (17) by a metal plate (15) on which two holes (28) are embedded by metal screws (16) and five rows of static magnetic coil stators (152) with a distance of eight millimeters by metal plates (8) on which there are precise holes for placing ball bearings in two different types (95 and 94). The stators are fastened together by six long bolts (6). At the end and beginning of these five rows of stators, two bearings (97) that are fixed with metal plates on the shell with metal pins (88) are used for smoother rotation.

Seventeen small symmetrical windings (129) and (5) with insulation (9) are arranged on each stator in a precise and regular manner with air distance (7) in which the electrical input wires are made through two slots (46 and 44). Which is created longitudinally on the axis (10) is transmitted to the primary control circuit (113). The electrical connection of the stators is established by printed circuit fibers (37) and platinum placed on insulating plates (38) designed and manufactured for this purpose. Longitudinal grooves (31) are designed on the shell of the electric motor (17) which are responsible for cooling (Heatsink) with regular air distance. (33) is the part of the shell that acts as the base of the motor, behind which is installed the terminal (27) of DC power input. This special configuration creates high and stable torque at all speeds (RPM) for the electric motor.

Coils used instead of permanent magnets can have different shapes. For example, a cubic cylinder, a trapezoid, or other suitable shapes may be appropriate. But to achieve smooth and stable torque, the design of the interlayer coil and the disc-shaped coil is of particular importance for producing sinusoidal smooth wave output. It also enables Micro stepped operation to control the slow motion of the electric motor.

### Advantage Effects of Invention

One of the advantages of this special motor is the cost reduction by reducing the amount of copper used in the coils and the size required to be placed in them. For example, the weight of a copper coil in an electric motor is proportional to the magnitude of the current. The larger the current number, the heavier the wire. This relationship is not linear but is secondary. In the electromotor, each coil or (any number of independent coils) controls a relatively small amount of current using a large number of small magnetic coils. This electric motor uses less copper wire so that the loss of resistance power is significantly equal to the loss of resistance power of a motor similar to coils. The stored copper relative to the number of cn coils in this motor saves potential costs compared to the number of dn of coils in previously made electric motors.

This electric motor requires five times fewer copper wires than a three-phase electric motor with a permanent magnet that has the same power. Having five times less wire reduces the amount of iron core needed to inflate the wires around them. As a result, the whole unit can be mounted in a smaller chamber, which further reduces the mass of the material. If the body of the electric motor is made of a good conductor such as aluminum, it can be used as a coolant and in addition reduces the mass of the material used, a weight that is reduced by at least 20%. Another special advantage of this design can be the configuration to continuously optimize the coil time. For example, if the sum of more than the entire operating area of an electric motor, it provides savings of up to 40%. In the axial configuration, certain visualizations of the current disclosure can reduce the total number of permanent magnets by at least 25%. The overall savings rate increases with the number of rotors required, and this can be done by sharing a common rotor and using both rotor magnetic fields instead of one.

The following benefits can also be mentioned:
Low energy consumption at high powers compared to previous technologies
Reduce magnetic force losses and reduce heat production
Low volume and light
Able to produce effective torque within the defined power range
Lack of brush and commutator system and reduction of friction losses
Able to generate effective power in all periods of the increased RPM range
Easily controllable by electronic controllers.

### BRIEF DESCRIPTION OF DRAWINGS

FIG. 1: This figure shows a longitudinal cross-sectional view of an electric motor subject to the invention.

FIG. 2: This figure shows an incomplete view of one side of the disc stator of a three-phase DC electric motor.

FIG. 3: This defective surface view of the other side of the electric motor disc stator shows the subject of the invention.

FIG. 4: This figure shows the partial shear view of the electromagnetic coils.

FIG. 5: This figure shows a schematic diagram of three-phase DC electromotor electronic systems.

FIG. 6: This figure shows a schematic overview of a plotter rotor and the coil configuration according to the specific claim.

FIG. 7: This figure shows a complete configuration of FIG. 6.

FIG. 8: This figure is a cross-sectional view of the linear arrangement of the body and the winding configuration shown in the figure. This figure shows the geometric arrangement of the coils in the stator.

FIG. 9: This figure shows the configuration of the control circuit of the electric motor coils.

FIG. 10: Schematic view of voltage controlled oscillator circuit

FIG. 11: This figure shows the configuration in which a motion control unit is connected to one or more coil control units and is connected to a common communication bus.

FIG. 12: This figure shows the force-torque comparison diagram of the invention.

FIG. 13: Block diagram of a phase lock loop

### DESCRIPTION OF EMBODIMENTS

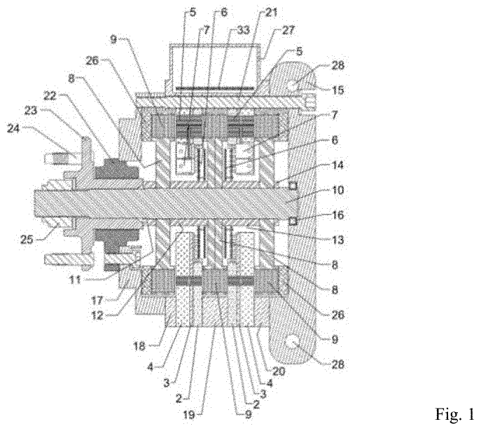

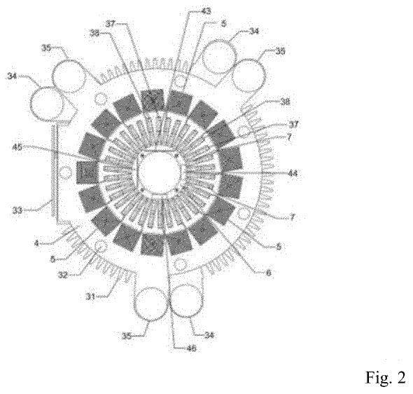

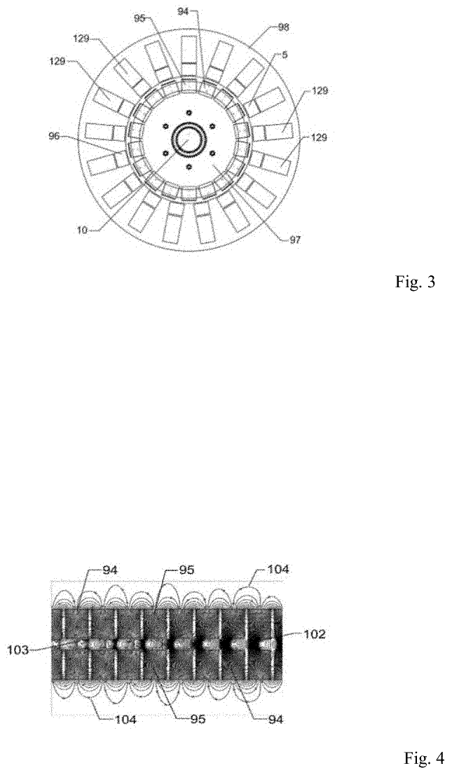

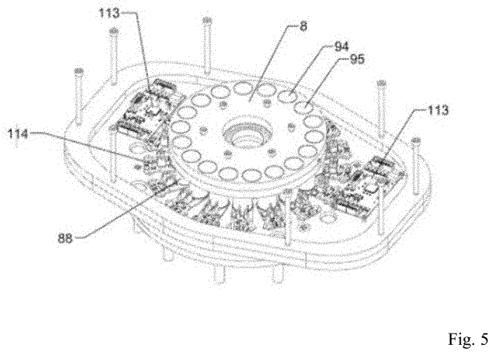

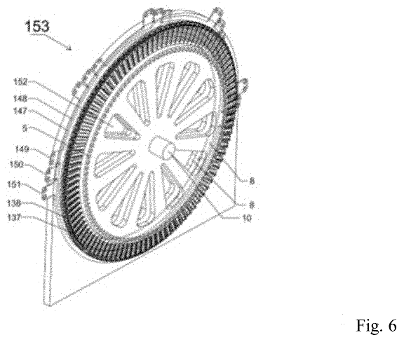

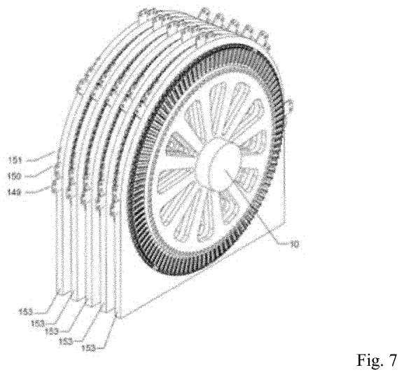

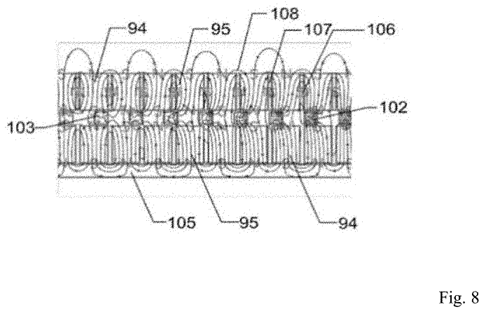

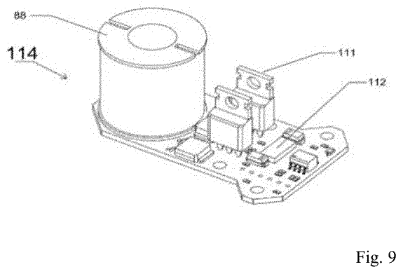

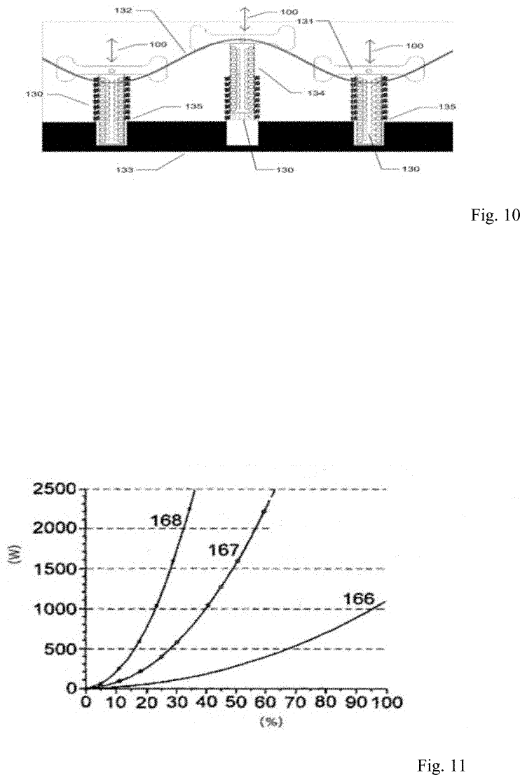

As disclosed in [FIG. 1], the following description of the parts is explained:
1 Shape cut from longitudinal section
2 Disc connection base
3 Thin insulation between disc-shaped plates
4 Disc-shaped plate
5 Asymmetric screw wires
6 Oscillator circuit screw holder
7 Air distance of oscillating circuit transistors
8 Plates metal separator of magnetic disks
9 Insulation between metal plates
10 Middle Axis
11 Wired Third Floor Round Axis
12 Wired Second Floor Round Axis
13 Wired First Floor Round Axle
14 Metal Pins Metal Plates Separating Magnetic Discs
15 Main Metal Sheet Bottom
16 Metal screws
17 Aluminum shell
18 Insulation base between the third-floor plates
19 Insulation base between the second-floor plates
20 Insulation base between the first-floor plates
21 Longitudinal gap groove of the terminal base
22 Fixing piece of the bearing base with the shell
23 Bearing stand
24 Electromotor upper door holder screw
25 Shaft bearing
26 Metal plate fastening piece
27 Power input terminal base
28 Lower main metal screw hole
29 Power input cable
30 Input power connection socket
31 Longitudinal grooves of aluminum shell
32 Holes of disc-shaped plates
33 The lateral base of the engine

[FIG. 2] discloses the following part:
4 Disc-shaped plate
5 Asymmetric screw wires
6 Oscillator circuit screw holder
7 Air distance of oscillating circuit transistors
33 The lateral base of the engine
34 First-floor disc plate fiber
35 Second-floor disc plate fiber
36 Disc plate adjustment holes FIG.
37 Printed fiber
38 Insulation plates
39 Asymmetric coil connection socket
44 Main input wire slot
45 Symmetric coil connection socket
46 Main input wire slot

[FIG. 3] discloses the following part numbers:
8 Plates metal separator of magnetic disks
9 Insulation between metal plates
10 Middle Axis
94 Small ball bearings
95 Large ball bearings
96 Asymmetric coil wires
97 Bearings
98 Symmetric and asymmetrical coil plate circuit
129 Symmetric coil wires

[FIGS. 4 and 5] disclose the following part numbers:
102 A connection point of S coils
103 A connection point of N coils
88 Metal pin in the middle of the coil on the oscillator circuit
113 (Primary control circuit) MCU
114 Oscillator (high and variable voltage oscillator circuit)

[FIG. 6] discloses the following parts:
9 Insulation between metal plates
10 Middle Axis
135 Three-phase fixed coils
137 Symmetrical coil bases
147 Thin insulation plate between the first and second-floor magnetic disc coils
148 Thin insulation plate between second and third-floor magnetic disk coil
149 Magnetic disk coil first floor
150 Second-floor magnetic disk coil
151 Magnetic disc coil third floor
152 Triangular grooves on disc plates (with cooling capability when rotating)
153 A set of disk-shaped magnetic coils

[FIG. 8] discloses the following:
102 A connection point of S coils
103 A connection point of N coils 105-106-107-108.
   The linear arrangement of windings and geometric arrangement of stator coils

[FIG. 9] discloses the following:
88 Metal pin in the middle of the coil on the oscillator circuit
111 Transistor
112 Quick diode
113 MCU (Primary control circuit)
114 Oscillator (high and variable voltage oscillator circuit)

[FIG. 11] discloses the following parts:
100 Frequency range
130 The amount of rotor movement at rest and peak
132 Frequency waveform
134 Rotor
135 Three-phase fixed screw wires

[FIG. 12] This figure shows the force-torque comparison diagram of the invention.

[FIG. 13] is a Block diagram of a phase lock loop.

### EXAMPLES

This invention is related to the field of DC electric motors and can be used in the construction of electric motorcycles and all-electric vehicles with high power and low energy consumption with point-to-point control capability. Since today's electric motorcycles usually use a type of electric motor called HUB MOTOR, these motors are installed in the center of the rear wheel of the motorcycle, and in fact, the motor shell is the same wheel and therefore the motor power is limited to the central diameter of the wheel.

Power transmission in this type of motorcycle is done by timing belts. In this type of power transmission, according to the simple law of wheels and axles, it is possible to design more than five types of electric motorcycles with different powers at different speeds with a three-phase electric motor with constant power. Also, the use of this type of electric motor in the construction of electric motorcycles provides high power, the appropriate speed, and minimum energy consumption for the user and promotes a culture of using clean energy. It is worth mentioning that this three-phase electric motor made for electric motorcycle has a power of 4200 watts, which can be increased.

### INDUSTRIAL APPLICABILITY

This type of electric motor can be used in various industries due to its advantages such as clean energy, low volume, high power, low energy consumption, and torque control capability, especially in transportation and industrial engineering. The application of BLDC three-phase electric motors in industries focuses on production engineering or industrial automation and is ideally suited for manufacturing applications due to its high power, density, speed characteristic, good torque, high efficiency, and low maintenance costs.

While preferred embodiments of the present invention have been shown and described herein, it will be obvious to those skilled in the art that such embodiments are provided by way of example only. Numerous variations, changes, and substitutions will occur to those skilled in the art without departing from the invention. It should be understood that various alternatives to the embodiments of the invention described herein, may be employed in practicing the invention. It is intended that the following claims define the scope of the invention and that methods and structures within the scope of these claims and their equivalents be covered thereby.

1- A three-phase DC direct current electric motor, having disc coils comprising:
At least 12 independent coils;
a rotor;
at least one disc-shaped stator; and
an electronic control system.

2- The electric motor of claim 1, wherein said at least 12 independent coils having three separate phases, and are connected by switch circuits, in three quadruple rows; and wherein said switch circuits comprise of switching transistors.

3- The electric motor of claim 2, wherein said rotor comprises of a circular array of electromagnetic coils, having high energy; and wherein said electromagnetic coil further comprises embedded alternating polarity having magnetic characteristics, wherein an axis of said magnets is parallel to said rotor's shaft.

4- The electric motor of claim 3, wherein each one of said at least one disk-shaped stator comprises circular arrays of stator's electromagnetic coils arranging at equal intervals around central diameter of said rotor.

5- The electric motor of claim 4, wherein said at least one disc-shaped stator is fixed in parallel with said rotor, wherein each one of said disc-shaped stators are separated by small, even air gaps.

6- The electric motor of claim 5, wherein said electronic control system replaces a brush and commutator supplying energy to said magnetic coils, pushing and/or pulling said electromagnetic magnets, generating kinetic energy.

7- The electric motor of claim 6, wherein a central section of said at least one stator is cut, allowing a rotor carrier shaft to pass through, rotating a circuit of said electromagnetic coils to rotate said rotor integrated with said shaft.

8- The electric motor of claim 7, wherein said rotating rotor is supported in parallel with said at least one stator where said air gaps are located.

9- The electric motor of claim 8, wherein a switching system having oscillator circuits, utilizes said command signals from a control system, activating a power supply and three Hall sensors for three rows of coils having three phases, and further receiving signals from said oscillators.

10- The electric motor of claim 9, wherein due to low resistance and magnetic flux, a rapid or reverse change in polarity occurs in said switching system and said electromagnetic coils.

11- The electric motor of claim 10, wherein a simultaneous power distribution in said three-phase motor is provided by said electronic control circuit, utilizing said three separate rows of quadruple coils and removing said brush system and commutator.
